(19) United States
(12) Patent Application Publication
(10) Pub. No.: US 2026/0296247 A1
(43) Pub. Date: Oct. 1, 2026

(54) CONTROL SYSTEM, VEHICLE, CHARGING APPARATUS, TRAFFIC LIGHT, METHOD, AND RECORDING MEDIUM

(71) Applicant: NEC Corporation, Tokyo (JP)

(72) Inventors: Noriaki KOBAYASHI, Tokyo (JP); Masaru YANAI, Tokyo (JP); Makoto IWASAKI, Tokyo (JP); Motoharu OHTAKE, Tokyo (JP); Hideki MURAMATSU, Tokyo (JP); Noritsugu YAMANAKA, Tokyo (JP); Takashi KOJIMA, Tokyo (JP); Kosei KOBAYASHI, Tokyo (JP)

(73) Assignee: NEC Corporation, Tokyo (JP)

(21) Appl. No.: 19/477,283

(22) PCT Filed: May 25, 2023
(86) PCT No.: PCT/JP2023/019568

§ 371 Date: Oct. 21, 2025

(51) Int. Cl. B60L 53/62; B60L 53/12

(52) U.S. Cl. CPC B60L 53/62; B60L 53/12

(57) ABSTRACT

A control system (10) comprises: an identification unit (11) that identifies a vehicle (21, 22) which enters a charging section (CS) where contactless-type charging devices (50) are installed; a prediction unit (12) that calculates a predicted value of the charge amount expected when contactless-type charging of the vehicle is carried out by the charging devices; and a determination unit (13) that determines, on the basis of the predicted value, whether or not to set the vehicle as an object to be charged by the contactless-type charging devices.

### TECHNICAL FIELD

The present invention relates to a control system, a vehicle, a charging apparatus, a traffic light, a method, and a recording medium.

### BACKGROUND ART

PTL 1 discloses an example of a non-contact power feeding system that provides a power feeding section in which a ground power feeding device is buried in the ground and enables a traveling vehicle to receive necessary electric power. A travel mode suggestion apparatus described in PTL 1 has a function for suggesting a second travel route that travels through the power feeding section and in which an estimated power feeding amount becomes equal to or more than a reference power amount, in addition to a normal travel route that does not consider power feeding to a destination.

### CITATION LIST

### Patent Literature

PTL 1: JP 2023-20483 A

### SUMMARY OF INVENTION

### Technical Problem

In a case of charging during traveling, because a distance between a power feeding device and a power receiving device on a vehicle side constantly fluctuates, it is said that electric power larger than that for charging in a stopping state is needed. Therefore, from a viewpoint of a power transmission capability of a power supply or a ground power feeding device that can be obtained, there is a possibility that the number of chargeable vehicles in a single power feeding section is limited. For example, as a travel mode suggestion apparatus in PTL 1, by guiding a vehicle to a specific power feeding section, the number of vehicles traveling toward this section increases. However, in that case, a situation is assumed where it is not possible to feed electric power to all the vehicles.

An object of the present disclosure is to provide a control system, a vehicle, a charging apparatus, a traffic light, a method, and a recording medium that select a power supply target vehicle from among vehicles that desire to be charged during traveling described above.

### Solution to Problem

According to a first aspect, a control system is provided that includes a specification unit that specifies a vehicle that enters a charging section in which a non-contact type charging apparatus is installed, a prediction unit that calculates a prediction value of an expected charging amount, in a case where the charging apparatus performs non-contact type charging on the vehicle, and a determination unit that determines whether to set the vehicle as a charging target by the non-contact type charging apparatus, based on the prediction value.

According to a second aspect, a vehicle is provided that includes a receiving unit that receives a charging instruction from a control system that selects a vehicle to be charged by a non-contact type charging apparatus, from among vehicles that enter a charging section in which the non-contact type charging apparatus is installed, and a charging control unit that communicates with the non-contact type charging apparatus based on the charging instruction and starts non-contact type charging.

According to a third aspect, a non-contact type charging apparatus is provided that includes a receiving unit that receives a charging instruction from a control system that selects a vehicle to be charged by a non-contact type charging apparatus, from among vehicles that enter a charging section in which the non-contact type charging apparatus is installed, and a charging control unit that communicates with the vehicle based on the charging instruction and starts non-contact type charging.

According to a fourth aspect, a traffic light is provided that changes an indication pattern, based on an instruction from a control system that selects a vehicle to be charged by a non-contact type charging apparatus, from among vehicles that enter a charging section in which the non-contact type charging apparatus is installed.

According to a fifth aspect, a charging control method is provided including specifying a vehicle that enters a charging section in which a non-contact type charging apparatus is installed, calculating a prediction value of an expected charging amount, in a case where the charging apparatus performs non-contact type charging on the vehicle, and determining whether to set the vehicle as a charging target by the non-contact type charging apparatus, based on the prediction value.

According to a sixth aspect, a method for charging a vehicle is provided including receiving a charging instruction from a control system that selects a vehicle to be charged by a non-contact type charging apparatus, from among vehicles that enter a charging section in which the non-contact type charging apparatus is installed, and communicating with the non-contact type charging apparatus based on the charging instruction and starting non-contact type charging.

According to a seventh aspect, a recording medium is provided that records a program for achieving a function of each of the vehicle, the charging apparatus, and the traffic light.

### Advantageous Effects of Invention

According to the present disclosure, a control system, a vehicle, a charging apparatus, a traffic light, a method, and a recording medium are provided that can select a power supply target vehicle from among vehicles that desire to be charged during traveling.

### BRIEF DESCRIPTION OF DRAWINGS

FIG. 1 is a diagram illustrating a configuration of an example embodiment of the present disclosure.

FIG. 2 is a flowchart illustrating an operation of an example embodiment of the present disclosure.

FIG. 3 is a sequence diagram illustrating an operation between a vehicle and a charging apparatus according to an example embodiment of the present disclosure.

FIG. 4 is another sequence diagram illustrating the operation between the vehicle and the charging apparatus according to an example embodiment of the present disclosure.

FIG. 5 is a diagram illustrating a configuration of a first example embodiment of the present disclosure.

FIG. 6 is a functional block diagram illustrating a detailed configuration of the first example embodiment of the present disclosure.

FIG. 7 is a diagram illustrating an example of vehicle information used by a control system of the first example embodiment of the present disclosure.

FIG. 8 is a sequence diagram illustrating an operation of the first example embodiment of the present disclosure.

FIG. 9 is a functional block diagram illustrating a detailed configuration of a second example embodiment of the present disclosure.

FIG. 10 is a diagram illustrating an example of vehicle information used by a control system of the second example embodiment of the present disclosure.

FIG. 11 is a diagram illustrating a configuration of a third example embodiment of the present disclosure.

FIG. 12 is a functional block diagram illustrating a detailed configuration of the third example embodiment of the present disclosure.

FIG. 13 is a sequence diagram illustrating an operation of the third example embodiment of the present disclosure.

FIG. 14 is a functional block diagram illustrating a detailed configuration of a fourth example embodiment of the present disclosure.

FIG. 15 is a sequence diagram illustrating an operation of the fourth example embodiment of the present disclosure.

FIG. 16 is a diagram illustrating a configuration of a computer configuring an information processing apparatus of the present disclosure.

### EXAMPLE EMBODIMENT

First, an outline of example embodiments of the present disclosure will be described with reference to the drawings. Reference numerals assigned in the drawings of the outline are assigned to each element for convenience as an example for the sake of convenience to facilitate understanding, and are not intended to limit the present disclosure to any mode shown in drawings. An individual connection line between blocks in the drawings and the like referred to in the following description includes both bidirectional and unidirectional. A unidirectional arrow schematically indicates a flow of a principal signal (data), and does not exclude bidirectionality. A program is executed by a computer apparatus, and the computer apparatus includes, for example, a processor, a storage device, an input device, a communication interface, and a display device as necessary. The computer apparatus is configured to be communicable with devices (including a computer) inside or outside the device via a communication interface in a wired or wireless manner. Although there are ports and interfaces at connection points of input and output of each block in the relevant drawings, illustration of the port or interface is omitted.

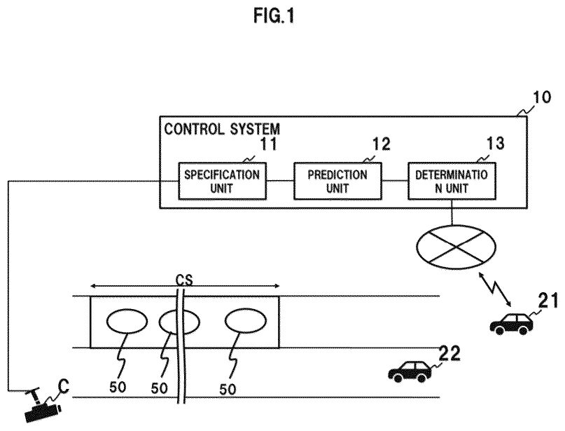

In one example embodiment, the present disclosure can be achieved by a configuration including a control system 10, vehicles 21 and 22, and a charging apparatus 50, as illustrated in FIG. 1. The control system 10 includes a specification unit 11, a prediction unit 12, and a determination unit 13. In the following description, it is described as assuming that the vehicles 21 and 22 are electric automobiles that can be charged during traveling from the charging apparatus 50. Of course, the vehicles 21 and 22 are not limited to electric automobiles that are provided with only a motor as a drive source and may be a hybrid car provided with a combustion engine, or the like.

The specification unit 11 specifies the vehicle 21 that enters a charging section CS where the non-contact type charging apparatus 50 is installed. In a case where the charging apparatus 50 performs non-contact type charging on the vehicle 21, the prediction unit 12 calculates a prediction value of an expected charging amount. The determination unit 13 determines whether to set the vehicle as a charging target by the non-contact type charging apparatus 50, based on the prediction value.

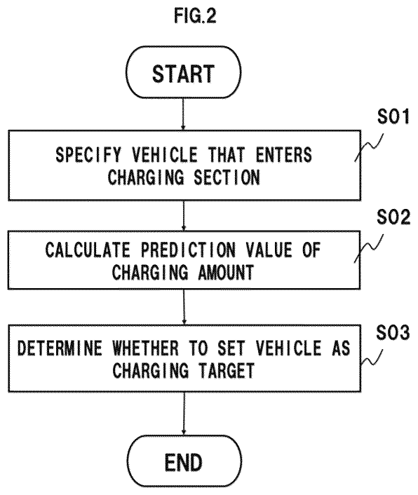

The control system 10 configured as described above operates as follows. First, the control system 10 specifies the vehicle 21 that enters the charging section CS, with an image captured by a camera C or the like (step S01 in FIG. 2). The vehicle 21 that enters the charging section CS may be specified using various sensors for detecting the entry of the vehicle, instead of the camera C. By acquiring position information or the like from the vehicle as in a first example embodiment to be described later, the vehicle 21 that enters the charging section CS may be specified.

Next, in a case where the non-contact type charging is performed on the vehicle 21 by the charging apparatus, the control system 10 calculates the prediction value of the expected charging amount (step S02 in FIG. 2). Next, the control system 10 determines whether to set the vehicle 21 as the charging target by the non-contact type charging apparatus 50, based on the prediction value (step S03 in FIG. 2). The determination (charging instruction) as to whether to set the vehicle 21 as the charging target is directly or indirectly notified to at least one of the vehicle 21 or the charging apparatus 50. This determination (charging instruction) may include a password, electronic authentication information, or the like for the vehicle 21 and the charging apparatus 50 to authenticate each other, in order to prevent use by a third party.

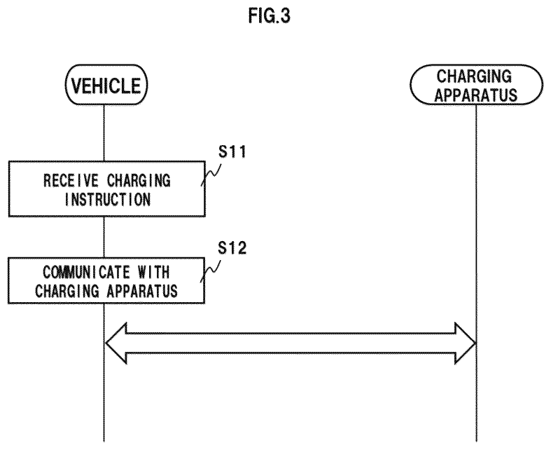

FIG. 3 is a sequence diagram illustrating an operation between the vehicle and the charging apparatus started in a case where the vehicle 21 is notified of the determination (charging instruction) as to whether to set as the charging target. Upon receiving the charging instruction from the control system 10 (step S11), the vehicle 21 communicates with the non-contact type charging apparatus 50, based on the charging instruction and starts the non-contact type charging (step S12).

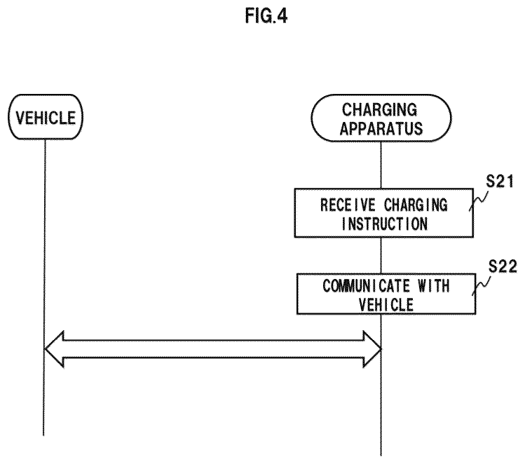

FIG. 4 is a sequence diagram illustrating an operation between the vehicle and the charging apparatus started in a case where the charging apparatus 50 is notified of the determination (charging instruction) as to whether to set as the charging target.

Upon receiving the charging instruction from the control system 10 (step S21), the charging apparatus 50 communicates with the non-contact type vehicle 21, based on the charging instruction and starts the non-contact type charging (step S22).

As described above, according to the present example embodiment, in a case where the charging apparatus performs the non-contact type charging, it is possible to determine whether to set the vehicle 21 that enters the charging section CS as the charging target, based on the prediction value of the expected charging amount. For example, in a case where the prediction value of the expected charging amount is very low, the vehicle 21 can be excluded from the charging target by the non-contact type charging apparatus 50. In this way, it is possible to allocate limited charging resources to another vehicle.

### First Example Embodiment

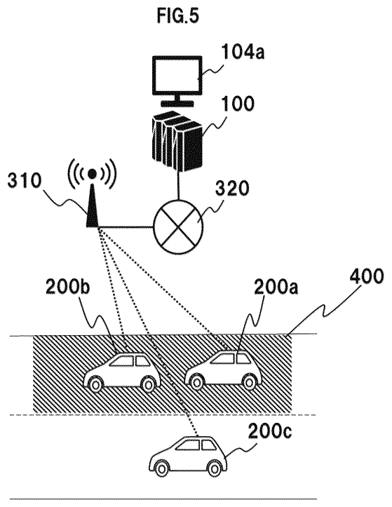

Next, a first example embodiment in which a vehicle to be charged is collectively determined for a plurality of vehicles positioned in one or more charging sections CS will be described in detail with reference to the drawings. In the present example embodiment, the vehicle to be charged is selected using a charging time which is a time when the vehicle has traveled the charging section for convenience, as a prediction value of a charging amount. FIG. 5 is a diagram illustrating a configuration of the first example embodiment of the present disclosure. Referring to FIG. 5, a configuration is illustrated in which an EV charging control system 100 and vehicles 200a to 200c are connected via a base station 310 and a mobile communication network 320. The EV charging control system 100 is connected to a display device 104a that displays a screen for management. A hatched region in FIG. 5 indicates a charging section (charging lane) 400. In this charging section, a charging apparatus is disposed along a traveling direction of a road. Among vehicles that have entered the charging section 400, the selected vehicles 200a and 200b can perform charging during traveling for being charged while traveling. Hereinafter, in a case where the vehicles 200a to 200c are not particularly distinguished from each other, the vehicles 200a to 200c are referred to as “vehicle 200”, and the EV charging control system 100 is referred to as “control system 100”. In the following description, it is described as assuming that the vehicle 200 is an electric automobile that can be charged from a power feeding device 500 during traveling.

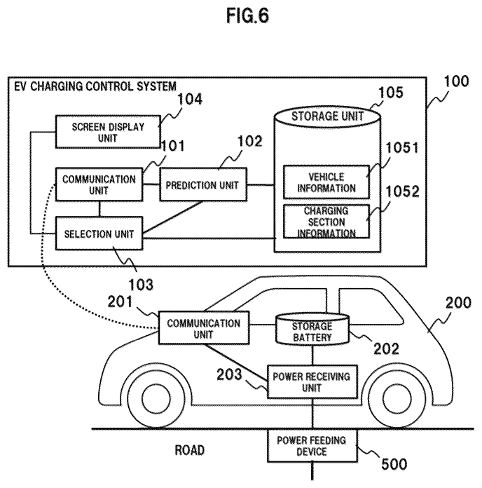

FIG. 6 is a functional block diagram illustrating a detailed configuration of the first example embodiment of the present disclosure. The control system 100 includes a communication unit 101, a prediction unit 102, a selection unit 103, a screen display unit 104, and a storage unit 105.

The communication unit 101 receives information necessary for prediction of the charging time (path, speed, SoC information, and the like) from the vehicle 200, via the base station 310 and the mobile communication network 320. The path may be, for example, time-series data of position information acquired by a global positioning system (GPS) or a real time kinematic (RTK) positioning function mounted on the vehicle 200. The communication unit 101 stores the information received from the vehicle 200, in the storage unit 105, as vehicle information. In the present example embodiment, since this communication unit 101 specifies the vehicle 200 that enters the charging section CS, the communication unit 101 corresponds to the specification unit 11 described above.

The prediction unit 102 predicts a charging time of each vehicle, using the vehicle information stored in the storage unit 105 and charging section information.

This charging time can be very simply obtained by dividing a length of the charging section by a speed of each vehicle. Of course, a charging amount that can be directly charged may be obtained, instead of the charging time. The charging amount in this case can be obtained by multiplying charging power per unit time for a combination of the vehicle and the charging apparatus, by the charging time. In a case where direction information of the vehicle 200 can be acquired from the vehicle information, the prediction unit 102 may predict that the vehicle 200 enters or exits from the charging section based on a lane change and predict the charging time.

The screen display unit 104 displays a charging target vehicle selection result by the selection unit 103, the information stored in the storage unit, or the like, on the display device 104a.

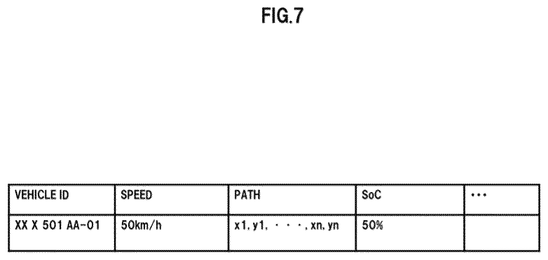

The storage unit 105 stores vehicle information 1051 and charging section information 1052. FIG. 7 is a diagram illustrating an example of the vehicle information 1051. In the example in FIG. 7, vehicle information that can manage license plate information (vehicle ID), speed information, path information, and SoC information is illustrated for each vehicle. Among these pieces of information, although the communication unit 101 may acquire the vehicle ID from the vehicle 200, the vehicle ID may be set in advance at the time of initial setting.

The charging section information is information indicating a range of the charging section on a map. By plotting a path of the vehicle 200 on the charging section information, a distance that the vehicle 200 travels in the charging section can be specified. In a case where the vehicle 200 enters the charging section and exits the charging section without changing the lane, a time required to travel an entire length of the charging section is the charging time. As described above, in a case where the vehicle 200 enters/exits from the charging section by changing the lane, the charging time is shorter than that when the vehicle 200 travels the entire length of the charging section. As the charging section information, a capability or the like of the power feeding device 500 installed in each charging section may be held.

The selection unit 103 selects the vehicle to be charged, based on the prediction value of the charging time of each vehicle that has been predicted. As a rule for selecting the vehicle to be charged by the selection unit 103, a combination of one or more of following various rules can be used. The number of vehicles selected as the charging target by the selection unit 103 may be a predetermined number according to the capability or the like of the power feeding device 500 or the number according to a traffic volume within a range of the capability of the power feeding device 500.

(0) Vehicles that do not pass through the charging section are excluded.

Whether a vehicle passes through or does not pass through the charging section can be determined based on the path information acquired from the vehicle 200. For example, by excluding the vehicle 200c positioned outside the charging section in FIG. 5, the charging target can be narrowed down to the vehicles 200a and 200b.

(1) A vehicle of which a charging time is less than a predetermined threshold is excluded from the charging target.

This is because, in a case where the charging time is very short, the charging amount is also small.

(2) A vehicle with a short charging time is prioritized, among the vehicles of which the charging time is equal to or longer than the predetermined threshold.

By prioritizing the vehicle with the short charging time, the vehicle having the short charging time can have a charging opportunity.

(3) A vehicle with a low SoC or a short travelable distance is prioritized.

The vehicle with the low SoC value is selected as the charging target, based on the SoC value of each vehicle. In this way, a vehicle that is likely to be out of power can be preferentially set as the charging target. Alternatively, the travelable distance may be calculated, based on the SoC and data regarding the vehicle. In this case, the vehicle with the short travelable distance can be preferentially set as the charging target. As the data regarding the vehicle, data related to the travelable distance such as an electric power consumption performance or a load weight is exemplified.

(4) The charging amounts of the vehicles positioned in the same charging section are adjusted to be uniform.

The idea is to avoid that only a specific vehicle is set as a charging target and to enable as many vehicles as possible to be equally charged.

The communication unit 101 notifies the vehicle 200 selected by the selection unit 103 of whether charging is possible.

The vehicle 200 includes a communication unit 201, a storage battery 202, and a power receiving unit 203. When entering the charging section, the communication unit 201 notifies a control system 100 side of the entry to the charging section. Upon receiving the notification indicating that the charging is possible from the control system 100, the communication unit 201 transfers the content to the power receiving unit 203.

Upon receiving the notification indicating that the charging is possible, the power receiving unit 203 receives power supply from the power feeding device 500 installed on a road surface and charges the storage battery 202.

The power feeding device 500 is installed on the road surface of the road and charges a traveling vehicle during traveling.

The base station 310 is a base station of the mobile communication network 320. For example, the mobile communication network 320 is a mobile communication network of a fifth generation mobile communication system (5G) or a long term evolution (LTE). Instead of the base station 310 and the mobile communication network 320, a facility for road-to-vehicle communication may be used.

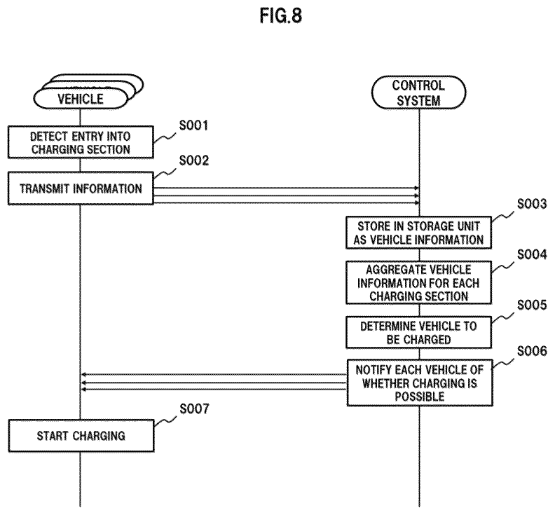

Next, an operation of the present example embodiment will be described in detail with reference to the drawings. FIG. 8 is a sequence diagram illustrating an operation of the first example embodiment. Referring to FIG. 8, first, the vehicle 200 enters the charging section or detects that the vehicle 200 is about to enter the charging section (step S001) and transmits the information such as the path, the speed, or the SoC information to the control system 100 side (step S002). This information includes the path, the speed, the SoC information, and the like of the vehicle, as described above.

The control system 100 acquires the vehicle information from each vehicle 200 as described above and registers the vehicle information in the storage unit 105 (step S003).

Next, the control system 100 aggregates the vehicle information for each charging section (step S004) and determines a vehicle to be charged (step S005). At this time, the control system 100 selects the vehicle to be charged, based on the charging time of each vehicle and the content of the SoC.

Next, the control system 100 notifies each vehicle 200 of whether charging is possible (step S006).

Among the vehicles 200 that have received the notification, the vehicle 200 that has received the notification indicating that the charging is possible activates the power receiving unit 203 and starts charging (step S007).

The control system 100 and the vehicle 200 execute the processing in steps S001 to S007, at predetermined time intervals. The predetermined time interval is appropriately set according to the length of the charging section, an assumed average speed of the vehicle, or the like.

As described above, according to the present example embodiment, it is possible to select an appropriate vehicle from the vehicles positioned in the charging section and instruct to charge the vehicle. According to the present example embodiment, even a vehicle that has not been selected as the charging target can obtain a charging opportunity by reducing the speed. Conversely, although the vehicle with a high speed is preferentially selected as the charging target, the charging time decreases as the speed increases, and the charging amount decreases. As a result, an effect is obtained that it is possible to provide the charging opportunities to a large number of vehicles positioned in the charging section.

### second Example Embodiment

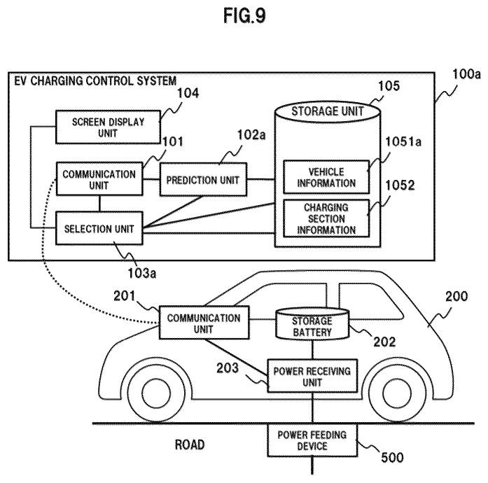

Next, a second example embodiment will be described in which a charging capability, a vehicle type, and subscribed service information are added to vehicle information and a charging target is more finely selected. FIG. 9 is a functional block diagram illustrating a detailed configuration of the second example embodiment. A difference from the first example embodiment illustrated in FIG. 6 is that vehicle information 1051a in the storage unit 105 is enriched and operations of a prediction unit 102a and a selection unit 103a are changed. Since other configurations are similar to those of the first example embodiment, the differences between the example embodiments will be mainly described below.

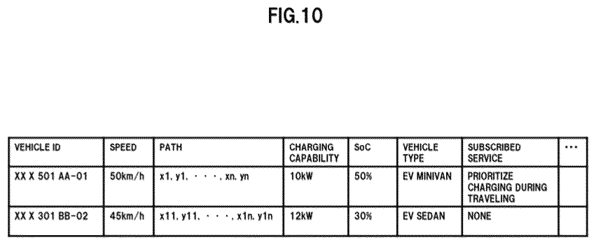

FIG. 10 is a diagram illustrating an example of vehicle information acquired from a vehicle 200 by a control system 100a according to the second example embodiment of the present disclosure. A difference from the vehicle information according to the first example embodiment illustrated in FIG. 7 is that the charging capability, the vehicle type, and the content of the subscribed service of each vehicle are added. As the charging capability, a capability per unit time for each vehicle is set. As the vehicle type, information indicating a body type such as an EV minivan or an EV sedan is set. As such a vehicle type, information indicating whether the EV is a plug-in EV may be further added. Instead of the vehicle type, a vehicle name, a grade, or the like set by a manufacturer may be set. As the subscribed service, information indicating whether a priority target service of a charging service during traveling is subscribed is set. That is, it can be said that the control system 100a according to the present example embodiment includes second acquisition means for acquiring information regarding a charging function of the vehicle 200 from the vehicle 200.

The prediction unit 102a predicts electric power that can be charged into each vehicle in a charging section, using the charging capability, in addition to a charging time. For example, a vehicle with a higher charging capability, among the vehicles traveling in the same charging section, has larger electric power that can be charged. In a case where a traveling distance in the charging section is short, even if the vehicle has the high charging capability, there is a case where a vehicle having a longer traveling distance in the charging section has larger electric power that can be charged even if the charging capability is low.

The selection unit 103a selects a vehicle to be charged, based on a prediction value of charging power of each vehicle that has been predicted. At that time, the selection unit 103 selects the vehicle to be charged, with reference to the vehicle type information or the subscribed service of each vehicle. For example, in a case where a rule that an EV minivan or an EV freight vehicle should be prioritized over an EV sedan is set, the selection unit 103 preferentially selects a vehicle ID “XX X 501 AA-01” over a vehicle ID “XX X 301 BB-02”, as the charging target. Similarly, for example, the selection unit 103 preferentially selects a vehicle that subscribes to the priority target service of charging during traveling as the charging target, than a vehicle with no subscribed service. A non-plug-in EV may be prioritized over the plug-in EV that has more charging opportunities. When the vehicle to be charged is selected, a score may be calculated according to the content of each item described above, and the vehicle to be charged may be selected, by comparing the scores aggregated for each vehicle.

As described above, according to the present example embodiment, the vehicle to be charged can be finely selected, based on the charging capability, the vehicle type, the subscribed service, or the like of each vehicle.

### Third Example Embodiment

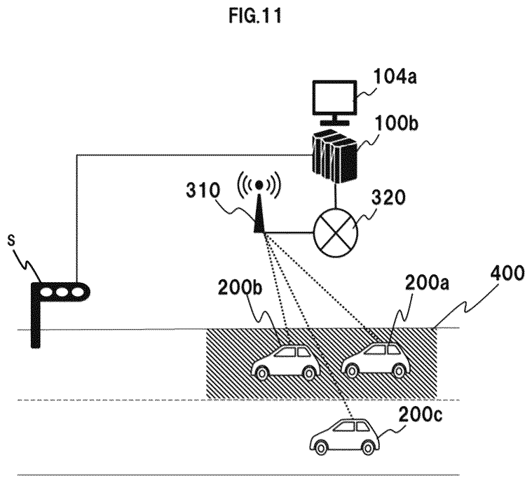

Next, a third example embodiment will be described in which a charging target is selected, using information regarding a traffic light on a front side of a charging section. FIG. 11 is a diagram illustrating a configuration of the third example embodiment of the present disclosure. A difference from the first example embodiment illustrated in FIG. 5 is that a control system 100b can acquire lighting pattern information of a traffic light S.

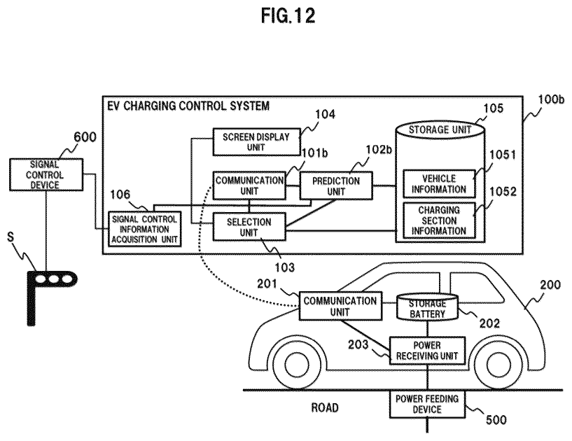

FIG. 12 is a functional block diagram illustrating a detailed configuration of the third example embodiment of the present disclosure. A first difference from the detailed configuration of the first example embodiment illustrated in FIG. 6 is that a signal control information acquisition unit 106 is added to the control system 100b. A second difference from the detailed configuration of the first example embodiment is that the prediction unit 102b predicts a charging time of each vehicle using the lighting pattern information of the traffic light S, in addition to vehicle information and charging section information. Since other configurations are similar to those of the first example embodiment, the differences between the example embodiments will be mainly described below.

The signal control information acquisition unit 106 acquires signal control information, from a signal control device 600 that controls the traffic light S, as the lighting pattern information of the traffic light S. This signal control information indicates a lighting pattern instructed by the signal control device 600 to the traffic light S, and it is possible to predict a stopping time or the like of a vehicle 200 positioned in the charging section, by referring to the signal control information.

The prediction unit 102b predicts the charging time of each vehicle using the signal control information of the traffic light S, in addition to the vehicle information and the charging section information. For example, in a case where an indication of a traffic light in FIG. 11 remains blue for a while, the prediction unit 102b calculates a time required for each vehicle 200 to pass through the charging section as the charging time, as in the first example embodiment. On the other hand, in a case where the indication of the traffic light in FIG. 11 changes and each vehicle 200 is expected to stop, the prediction unit 102b adds the stopping time to the charging time.

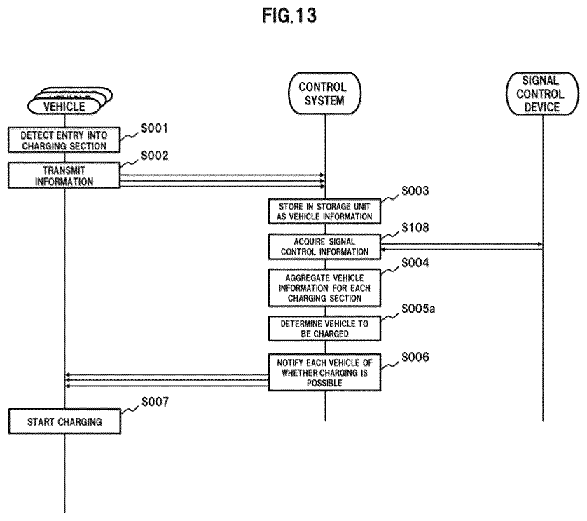

FIG. 13 is a sequence diagram illustrating an operation of the third example embodiment of the present disclosure. A difference from FIG. 8 illustrating the operation of the first example embodiment is that the control system 100b acquires the signal control information from the signal control device 600, after acquiring the vehicle information (step S108).

Then, after aggregating the vehicle information (step S004), the control system 100b predicts the charging time of each vehicle using the lighting pattern information of the traffic light S, and then, determines a vehicle to be charged (step S005a). Other operations are similar to those of the first example embodiment, and thus description thereof is omitted.

As described above, according to the present example embodiment, even in a case where the traffic light S exists on the front side of the charging section and the time required for the vehicle 200 to pass through the charging section varies, it is possible to accurately predict the charging time and appropriately select the vehicle to be charged. In the example embodiment described above, an example has been described where the traffic light S exists on the front side of the charging section. However, in a case where a railway crossing or the like exists instead of the traffic light S, similarly, it is possible to predict the charging time using a train timetable or the like.

A case is also conceivable where sections before and after the charging section are places where congestion is likely to occur. In this case, with an idea similar to the signal control information described above, the control system 100b may acquire a congestion occurrence status and predict the charging time based on the congestion occurrence status. This congestion occurrence status may be acquired as the vehicle information, or the control system 100b may estimate the congestion occurrence status from an image of a camera installed near the charging section or the like.

### Fourth Example Embodiment

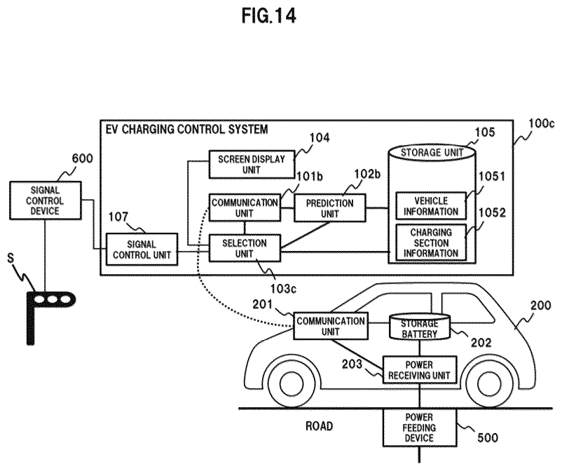

Next, a fourth example embodiment will be described in which a traffic light control function is added to a control system 100c. FIG. 14 is a diagram illustrating a detailed configuration of the fourth example embodiment of the present disclosure. A difference from the first example embodiment illustrated in FIG. 5 is that a signal control unit 107 is added to the control system 100c and an operation of a selection unit 103c. Since other configurations are similar to those of the first example embodiment, the differences between the example embodiments will be mainly described below.

The signal control unit 107 has a function for changing a lighting pattern of a traffic light S, by transmitting signal control information to a signal control device 600 that controls the traffic light S.

The selection unit 103c selects a vehicle to be charged, based on a prediction value of a charging time of each vehicle that has been predicted. Moreover, in order to increase a charging amount of a vehicle 200 to be charged as necessary, the selection unit 103 instructs the signal control unit 107 to change a lighting state of the traffic light S in such a way that the vehicle 200 to be charged stays in a charging section. For example, in a case where an expected SoC of the vehicle 200 to be charged after passing through the charging section is equal to or less than a predetermined threshold, the selection unit 103c instructs the signal control unit 107 to change lighting of the traffic light S to red, in order to avoid a power shortage and causes the vehicle 200 to stay in the charging section.

Therefore, the traffic light S has a function for changing an indication pattern, based on the instruction from the control system.

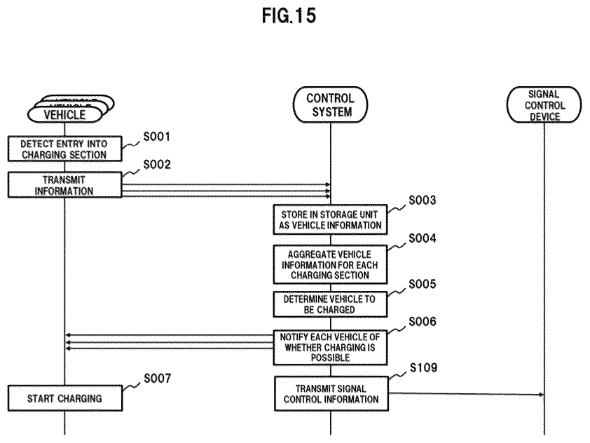

FIG. 15 is a sequence diagram illustrating an operation of the fourth example embodiment of the present disclosure. A difference from FIG. 8 illustrating the operation of the first example embodiment is that the control system 100c transmits the signal control information to the signal control device 600 (step S109) after notifying each vehicle 200 of whether charging is possible (step S006). Other operations are similar to those of the first example embodiment, and thus description thereof is omitted.

As described above, according to the present example embodiment, it is possible to increase the charging amount necessary for the vehicle 200, in addition to the selection of the vehicle 200 to be charged. In the example described above, an example has been described in which it is instructed to change the lighting of the traffic light S to red and the vehicle 200 is caused to stay in the charging section. However, a mode of control of the traffic light S by the control system 100c is not limited to this. For example, the control system 100c may perform an operation for shortening a red lighting time of the lighting of the traffic light S and move the vehicle 200 from the charging section earlier.

Although each of the example embodiments of the present disclosure is described above, the present disclosure is not limited to the above-described example embodiments, and further modifications, substitutions, and adjustments can be made without departing from the basic technical idea of the present disclosure. For example, the network configuration, the configuration of each element, and the representation form of data that are illustrated in the drawings are merely examples that facilitate understanding of the present disclosure, and the present disclosure is not limited to those illustrated in the drawings.

### Hardware Configuration

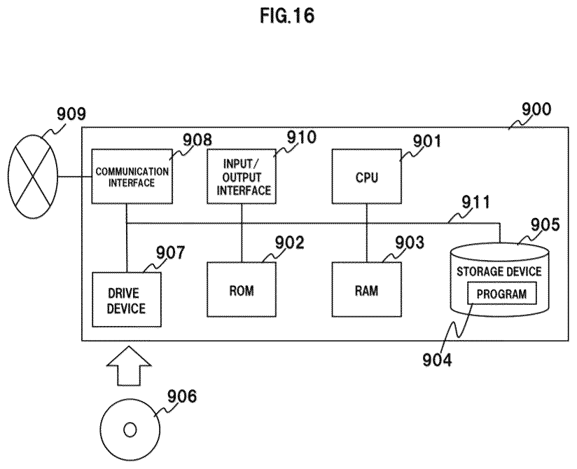

In each of the example embodiments of the present disclosure, each component of the apparatuses indicates a block of a functional unit. A part or all of the components of the apparatuses is achieved by, for example, any combination of an information processing apparatus 900 and a program, as illustrated in FIG. 16. FIG. 16 is a block diagram illustrating an example of a hardware configuration of the information processing apparatus 900 that achieves each component of each apparatus. The information processing apparatus 900 includes the following configuration as an example.
Central processing unit (CPU) 901
Read only memory (ROM) 902
Random access memory (RAM) 903
Program 904 loaded onto RAM 903
Storage device 905 that stores program 904
Drive device 907 that reads from and writes into recording medium 906
Communication interface 908 connected with communication network 909
Input/output interface 910 for inputting/outputting data
Bus 911 connecting between components

The components of the apparatuses in the example embodiments are achieved by the CPU 901 acquiring and executing the program 904 for achieving the functions. That is, the CPU 901 in FIG. 16 may execute a vehicle information aggregation program and a charging target selection program to perform update processing of calculation parameters stored in the RAM 903, the storage device 905, or the like. The program 904 for achieving the functions of the components of the apparatuses is stored in the storage device 905 or the ROM 902 in advance, for example, and is read by the CPU 901 as necessary. The program 904 may be supplied to the CPU 901 via the communication network 909, or may be stored in advance in the recording medium 906 to be read by the drive device 907 and supplied to the CPU 901.

Various modifications exist for the method of achieving the apparatuses. For example, the apparatuses may be achieved by any combination of the information processing apparatus 900 and individual programs for each component. A plurality of components included in the apparatuses may be achieved by any combination of one information processing apparatus 900 and one program. That is, units (processing means and functions) of an information processing apparatus described in the first to third example embodiments may be achieved by a computer program that causes a processor mounted in the apparatus to execute the processing described above by using the hardware.

A part or all of the components of the apparatuses may be achieved by other general-purpose or dedicated circuits, processors, and the like, or a combination thereof. The circuits and the like may be configured by a single chip or may be configured by a plurality of chips connected to each other via a bus.

A part or all of the components of the apparatuses may be achieved by a combination of the above-described circuits and the like and a program.

When a part or all of the components of the apparatuses is achieved by a plurality of information processing apparatuses, circuits, and the like, the plurality of information processing apparatuses, circuits, and the like may be arranged to be centralized or to be distributed. For example, the information processing apparatus, the circuit, and the like may be achieved as a form such as a client and server system or a cloud computing system in which the apparatuses or the like are connected via a communication network.

The above-described example embodiments are preferred example embodiments of the present disclosure, and the scope of the present disclosure is not limited only to the above-described example embodiments. That is, it is possible for those skilled in the art to modify or substitute the above-described example embodiments and construct a mode in which various modifications are made without departing from the gist of the present disclosure.

For example, in the first to fourth embodiments described above, all of the vehicles 200 are described as electric vehicles (EVs), but some of the vehicles 200 may be gasoline-powered vehicles or diesel-powered vehicles. In such a case, the control systems 100 to 100c can distinguish between electric vehicles (EVs), vehicles driven by internal combustion engines, and hybrid vehicles by acquiring information, by obtaining, as vehicle information from each vehicle 200, information indicating whether or not the vehicle is an electric vehicle (EV).

The third example embodiment and the fourth example embodiment may be implemented in combination. In this case, the control system has both the function for predicting the charging time from the lighting state of the traffic light S and the function for controlling the traffic light S and increasing/decreasing a charging period.

A part or all of the above example embodiments may be described as the following Supplementary Notes, but are not limited to the following.

### Supplementary Note 1

A control system including:
a specification unit configured to specify a vehicle that enters a charging section in which a non-contact type charging apparatus is installed;
a prediction unit configured to calculate a prediction value of an expected charging amount, in a case where the charging apparatus performs non-contact type charging on the vehicle; and
a determination unit configured to determine whether to set the vehicle as a charging target by the non-contact type charging apparatus, based on the prediction value.

### Supplementary Note 2

The prediction unit of the control system predicts a charging time, as the prediction value of the charging amount, and
the determination unit is capable of having a configuration for determining whether to set the vehicle as the charging target by the non-contact type charging apparatus, based on the prediction value of the charging time.

### Supplementary Note 3

The prediction unit of the control system is capable of having a configuration for predicting the charging amount, based on a passing time of the charging section calculated from a speed of the vehicle.

### Supplementary Note 4

The prediction unit of the control system is capable of having a configuration for further predicting the charging amount, based on a congestion occurrence status of a section including the charging section.

### Supplementary Note 5

The control system further including:
acquisition means for acquiring lighting pattern information of a traffic light on a front side of the charging section, in which
the prediction unit is capable of having a configuration for predicting the passing time of the charging section of the vehicle, based on the lighting pattern information of the traffic light.

### Supplementary Note 6

The control system further including:
second acquisition means for acquiring information regarding a charging function of the vehicle from the vehicle, in which
the prediction unit is capable of having a configuration for predicting the expected charging amount, based on the information regarding the charging function of the vehicle.

### Supplementary Note 7

The determination unit of the control system is capable of having a configuration for preferentially determining a vehicle having the smaller prediction value as a charging target.

### Supplementary Note 8

The determination unit of the control system is capable of having a configuration for excluding a vehicle of which the prediction value is less than a predetermined threshold from a charging target.

### Supplementary Note 9

The determination unit of the control system is capable of having a configuration for selecting a plurality of vehicles as charging targets in such a way that charging amounts of the plurality of vehicles passing through the charging section are equal to each other.

### Supplementary Note 10

The determination unit of the control system is capable of having a configuration for starting to charge the vehicle to be charged, by transmitting a charging instruction to at least one of the non-contact type charging apparatus or the vehicle.

### Supplementary Note 11

A vehicle including:
a receiving unit configured to receive a charging instruction from a control system that selects a vehicle to be charged by a non-contact type charging apparatus, from among vehicles that enter a charging section in which the non-contact type charging apparatus is installed; and
a charging control unit configured to communicate with the non-contact type charging apparatus based on the charging instruction and start non-contact type charging.

### Supplementary Note 12

A non-contact type charging apparatus including:
a receiving unit configured to receive a charging instruction from a control system that selects a vehicle to be charged by a non-contact type charging apparatus, from among vehicles that enter a charging section in which the non-contact type charging apparatus is installed; and
a charging control unit configured to communicate with the vehicle based on the charging instruction and start non-contact type charging.

### Supplementary Note 13

A traffic light that changes an indication pattern, based on an instruction from a control system that selects a vehicle to be charged by a non-contact type charging apparatus, from among vehicles that enter a charging section in which the non-contact type charging apparatus is installed.

### Supplementary Note 14

A charging control method including:
specifying a vehicle that enters a charging section in which a non-contact type charging apparatus is installed;
calculating a prediction value of an expected charging amount, in a case where the charging apparatus performs non-contact type charging on the vehicle; and
determining whether to set the vehicle as a charging target by the non-contact type charging apparatus, based on the prediction value.

### Supplementary Note 15

A method for charging a vehicle including:
receiving a charging instruction from a control system that selects a vehicle to be charged by a non-contact type charging apparatus, from among vehicles that enter a charging section in which the non-contact type charging apparatus is installed; and
communicating with the non-contact type charging apparatus based on the charging instruction and starting non-contact type charging.

### Supplementary Note 16

A method for charging a vehicle including:
receiving a charging instruction from a control system that selects a vehicle to be charged by a non-contact type charging apparatus, from among vehicles that enter a charging section in which the non-contact type charging apparatus is installed; and
communicating with the vehicle based on the charging instruction and starting non-contact type charging.

### Supplementary Note 17

A recording medium for recording a program for causing a computer to execute:
processing for specifying a vehicle that enters a charging section in which a non-contact type charging apparatus is installed;
processing for calculating a prediction value of an expected charging amount, in a case where the charging apparatus performs non-contact type charging on the vehicle; and
processing for determining whether to set the vehicle as a charging target by the non-contact type charging apparatus, based on the prediction value.

### Supplementary Note 18

A recording medium for recording a program for causing a computer to execute:
processing for receiving a charging instruction from a control system that selects a vehicle to be charged by a non-contact type charging apparatus, from among vehicles that enter a charging section in which the non-contact type charging apparatus is installed; and
processing for communicating with the non-contact type charging apparatus based on the charging instruction and starting non-contact type charging.

### Supplementary Note 19

A recording medium for recording a program for causing a computer to execute:
processing for receiving a charging instruction from a control system that selects a vehicle to be charged by a non-contact type charging apparatus, from among vehicles that enter a charging section in which the non-contact type charging apparatus is installed; and
processing for communicating with the vehicle based on the charging instruction and starting non-contact type charging.

The modes described in the above Supplementary Notes can be combined with each other after making necessary modifications. For example, a configuration having both the contents described in the Supplementary Note 2 and the contents described in the Supplementary Note 3 is also included in the disclosure range of the present specification.

The modes of the Supplementary Notes 11 to 19 can be expanded to the modes of the Supplementary Notes 2 to 9, as in the Supplementary Note 1.

The disclosures of each of the above PTLs is incorporated herein by reference, and may be used as the basis or a part of the present disclosure as necessary.

Modifications and adjustments of the example embodiments or examples are possible within the scope of the overall disclosure (including the claims) of present disclosure and based on the basic technical concept of the present disclosure. Various combinations or selections (including partial deletions) of various disclosure elements (including the elements in each of the claims, example embodiments or examples, drawings, and the like) are possible within the scope of the present disclosure. That is, the present disclosure of course includes various variations and modifications that could be made by those skilled in the art in accordance with the technical concept. The description discloses numerical value ranges. However, even if the description does not particularly disclose any numerical values or sub-range included within the ranges, these values and ranges should be construed to have been concretely disclosed.

Furthermore, the disclosures of the above-cited documents may be used, in part or in whole, in combination with the descriptions in this document, as part of this disclosure, in accordance with the gist of this disclosure, and such uses are deemed to be included in the disclosures of this application.

### REFERENCE SIGNS LIST

10 control system
11 specification unit
12 prediction unit
13 determination unit
21, 22 vehicle
50 charging apparatus
100, 100a to 100c EV charging control system
200, 200a to 200c vehicle
310 base station
320 mobile communication network
101 communication unit
102, 102a prediction unit
103, 103a selection unit
104 screen display unit
104a display device
105 storage unit
1051, 1051a vehicle information
1052 charging section information
201 communication unit
202 storage battery
203 power receiving unit
500 power feeding device
600 signal control device
900 information processing apparatus
901 central processing unit (CPU)
902 read only memory (ROM)
903 random access memory (RAM)
904 program
905 storage device
906 recording medium
907 drive device
908 communication interface
909 communication network
910 input/output interface
911 bus
CS charging section
S traffic light

What is claimed is:

1. A control system comprising:
a memory configured to store instructions; and
a processor configured to execute the instructions to:
specify a vehicle that enters a charging section in which a non-contact type charging apparatus is installed;
calculate a prediction value of an expected charging amount, in a case where the charging apparatus performs non-contact type charging on the vehicle; and
determine whether to set the vehicle as a charging target by the non-contact type charging apparatus, based on the prediction value.

2. The control system according to claim 1, wherein
the processor predicts a charging time, as the prediction value of the charging amount, and
determines whether to set the vehicle as the charging target by the non-contact type charging apparatus, based on a prediction value of the charging time.

3. The control system according to claim 1, wherein the processor predicts the charging amount, based on a passing time of the charging section calculated from a speed of the vehicle.

4. The control system according to claim 1, wherein the processor further predicts the charging amount, based on a congestion occurrence status of a section including the charging section.

5. The control system according to claim 1, further the processor
acquires lighting pattern information of a traffic light on a front side of the charging section, wherein
the processor predicts the passing time of the charging section of the vehicle, based on the lighting pattern information of the traffic light.

6. The control system according to claim 1, further the processor
acquires information regarding a charging function of the vehicle from the vehicle, wherein
the processor predicts the expected charging amount, based on the information regarding the charging function of the vehicle.

7. The control system according to claim 1, wherein the processor preferentially determines a vehicle having the smaller prediction value as a charging target.

8. The control system according to claim 1, wherein the processor excludes a vehicle of which the prediction value is less than a predetermined threshold from a charging target.

9. The control system according to claim 1, wherein the processor selects a plurality of vehicles as charging targets in such a way that charging amounts of the plurality of vehicles passing through the charging section are equal to each other.

10. The control system according to claim 1, wherein the processor starts to charge the vehicle to be charged, by transmitting a charging instruction to at least one of the non-contact type charging apparatus or the vehicle.

11.-12. (canceled)

13. A traffic light that changes an indication pattern, based on an instruction from a control system that selects a vehicle to be charged by a non-contact type charging apparatus, from among vehicles that enter a charging section in which the non-contact type charging apparatus is installed.

14. A charging control method comprising:
specifying a vehicle that enters a charging section in which a non-contact type charging apparatus is installed;
calculating a prediction value of an expected charging amount, in a case where the charging apparatus performs non-contact type charging on the vehicle; and
determining whether to set the vehicle as a charging target by the non-contact type charging apparatus, based on the prediction value.

15.-19. (canceled)

20. The control system according to claim 2, wherein the processor predicts the charging amount, based on a passing time of the charging section calculated from a speed of the vehicle.

21. The control system according to claim 2, wherein the processor further predicts the charging amount, based on a congestion occurrence status of a section including the charging section.

22. The control system according to claim 3, wherein the processor further predicts the charging amount, based on a congestion occurrence status of a section including the charging section.

23. The control system according to claim 2, further the processor
acquires lighting pattern information of a traffic light on a front side of the charging section, wherein
the processor predicts the passing time of the charging section of the vehicle, based on the lighting pattern information of the traffic light.

24. The control system according to claim 3, further the processor
acquires lighting pattern information of a traffic light on a front side of the charging section, wherein
the processor predicts the passing time of the charging section of the vehicle, based on the lighting pattern information of the traffic light.

25. The control system according to claim 4, further the processor
acquires lighting pattern information of a traffic light on a front side of the charging section, wherein
the processor predicts the passing time of the charging section of the vehicle, based on the lighting pattern information of the traffic light.

26. The control system according to claim 2, further the processor
acquires information regarding a charging function of the vehicle from the vehicle, wherein
the processor predicts the expected charging amount, based on the information regarding the charging function of the vehicle.

27. The control system according to claim 3, further the processor
acquires information regarding a charging function of the vehicle from the vehicle, wherein
the processor predicts the expected charging amount, based on the information regarding the charging function of the vehicle.
